(19) United States
(12) Patent Application Publication
(10) Pub. No.: US 2025/0027920 A1
(43) Pub. Date: Jan. 23, 2025

(54) HUMIDITY INDICATOR CARD INCLUDING CONDUCTIVE CARBON MATERIAL AND METHOD FOR MANUFACTURING THE SAME

(71) Applicant: GP&E Co., Ltd., Daejeon (KR)

(72) Inventor: Il Hoon Cho, Daejeon (KR)

(21) Appl. No.: 18/527,764

(22) Filed: Dec. 4, 2023

(30) Foreign Application Priority Data
Jul. 21, 2023 (KR) 10-2023-0095317

(51) Int. Cl. G01N 31/22; B41M 1/12; C09D 11/033; C09D 11/037; C09D 11/08; C09D 11/52

(52) U.S. Cl. CPC G01N 31/222; B41M 1/12; C09D 11/033; C09D 11/037; C09D 11/08; C09D 11/52

(57) ABSTRACT

Provided is a humidity indicator card including: blotting paper; antistatic layers disposed on upper and lower portions of the blotting paper; and humidity indication units disposed on one surface of the antistatic layer, wherein the antistatic layer includes an antistatic composition including conductive carbon black, and the conductive carbon black is included at 1 to 30 parts by weight based on 100 parts by weight of the antistatic composition, and the humidity indicator card may provide an excellent antistatic effect.

### CROSS-REFERENCE TO RELATED APPLICATIONS

This application claims priority under 35 U.S.C. § 119 to Korean Patent Application No. 10-2023-0095317, filed on Jul. 21, 2023, in the Korean Intellectual Property Office, the disclosure of which is incorporated herein by reference in its entirety.

### TECHNICAL FIELD

The following disclosure relates to a humidity indicator card including a conductive carbon material and a method for manufacturing the same.

### BACKGROUND

A humidity indicator card is a product allowing convenient confirmation of a change in relative humidity by discoloration of a humidity indicator due to a change in relative humidity, and may be enclosed mainly in the packaging of humidity-sensitive semiconductor chips, printed circuit boards (PCB), precision electronic devices, and the like. When the packaged product is opened, color changes of the humidity indicator card may be observed to simply determine whether a product is stable against humidity.

However, when an integrated circuit device and the humidity indicator card are sealed together, an electrostatic discharge (ESD) phenomenon due to friction which occurs when the humidity indicator card is in contact with a device may occur.

In particular, in the case of an integrated circuit device having a size of hundreds of nanometers, a voltage of hundreds to thousands of volts per unit area (1 μm²) is applied in a short time by electrostatic discharge, which may cause serious damage to the device and serious problems such as occurrence of fire and explosion. Therefore, a study of a humidity indicator card which may prevent an electrostatic discharge phenomenon causing serious defects in a device is needed.

### SUMMARY

An embodiment of the present invention is directed to providing a humidity indicator card having an antistatic function and a method for manufacturing the same.

In one general aspect, a humidity indicator card with an added antistatic function includes: blotting paper; antistatic layers disposed on upper and lower portions of the blotting paper; and humidity indication units disposed on one surface of the antistatic layer, wherein the antistatic layer includes an antistatic composition including conductive carbon black, and the conductive carbon black is included at 1 to 30 parts by weight based on 100 parts by weight of the antistatic composition.

In an exemplary embodiment, the antistatic composition may further include a binder and a solvent.

In an exemplary embodiment, the binder may include a rosin-based resin.

In an exemplary embodiment, the solvent may include a vegetable oil.

In an exemplary embodiment, the conductive carbon black may have a specific surface area of 50 to 100 m²/g.

In an exemplary embodiment, the conductive carbon black may have an oil absorption number (OAN) of 100 to 300 ml/100 g.

In an exemplary embodiment, the conductive carbon black may contain less than 300 ppm of sulfur.

In an exemplary embodiment, the blotting paper may have a moisture absorption degree of 40 to 200 seconds.

In an exemplary embodiment, the blotting paper may have a thickness of 400 to 500 μm.

In an exemplary embodiment, the humidity indicator card may have a surface resistance of 10³ to 10⁷ Ω/sq.

In an exemplary embodiment, the antistatic composition may further include a polypyrrole-based polymer.

In an exemplary embodiment, the humidity indication unit may not include the antistatic composition.

In another general aspect, a method for manufacturing a humidity indicator card with an added antistatic function includes: (S10) applying an antistatic composition including conductive carbon black on upper and lower portions of blotting paper to form antistatic layers; (S20) forming humidity indication units on one surface of the antistatic layer to manufacture a humidity indicator card; and (S30) drying the humidity indicator card, wherein the conductive carbon black is included at 1 to 30 parts by weight based on 100 parts by weight of the antistatic composition.

In an exemplary embodiment, a drying temperature in (S30) may be 40 to 100° C.

In an exemplary embodiment, the antistatic composition in (S10) may be applied excluding an area of the humidity indication unit.

In an exemplary embodiment, after (S10), (S15) cutting the blotting paper including the antistatic layer may be further included.

In an exemplary embodiment, after (S30), (S40) sealing the dried humidity indicator card may be further included.

Other features and aspects will be apparent from the following detailed description, the drawings, and the claims.

### BRIEF DESCRIPTION OF THE DRAWINGS

FIG. 1 is a drawing showing a humidity indicator card according to an exemplary embodiment.

FIG. 2 is a flow chart showing a method for manufacturing the humidity indicator card according to an exemplary embodiment.

FIG. 3 is a drawing showing blotting paper printed with an antistatic layer according to an exemplary embodiment.

FIGS. 4 to 7 are drawings showing the humidity indicator card according to an exemplary embodiment.

### DETAILED DESCRIPTION OF MAIN ELEMENTS

10: blotting paper
20: antistatic layer
30: humidity indication unit
100: humidity indicator card

### DETAILED DESCRIPTION OF EMBODIMENTS

A humidity indicator card including a conductive carbon material and a method for manufacturing the same of the present invention will be described in detail. The terms used in the present specification are selected to be as common terms as possible which are currently widely used while considering the function of the present invention, but they may vary depending on the intention of a person skilled in the art, a convention, the emergence of new technology, or the like. The technical and scientific terms used may have, unless otherwise defined, the meaning commonly understood by those of ordinary skill in the art.

The terms such as “comprise” or ““have” in the present specification and the appended claims mean that there is a characteristic or a constitutional element described in the specification, and as long as it is not particularly limited, a possibility of adding one or more other characteristics or constitutional elements is not excluded in advance.

A singular expression in the present specification and the appended claims includes a plural expression, unless otherwise explicitly specified as singular. In addition, a plural expression includes a singular expression, unless otherwise explicitly specified as plural.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms. Unless otherwise defined in the specification of the present invention, values which may be outside a numerical range due to experimental error or rounding off of a value are also included in the defined numerical range.

The term of degree such as “about” used in the present specification and the attached claims is used in the sense of covering an allowable error when the allowable error exists.

A humidity indicator card is enclosed with humidity-sensitive semiconductor chips, printed circuit boards (PCB), precision electronic devices, and the like, and allows simple determination of whether a product is stable against humidity when opened. However, a conventional common humidity indicator card has a very high surface resistance of about 10¹⁶ to 10¹⁸ Ω/sq. A humidity indicator card having insulation properties by its high surface resistance may cause static electricity due to friction and an electrostatic discharge (ESD) phenomenon, when it is in contact with an integrated circuit device enclosed together. Dust or foreign matter in the air is adsorbed into the integrated circuit device by static electricity and pollutes the device, and may cause defects in the integrated circuit device by electrostatic discharge or cause serious problems with safety such as fire and explosion.

Thus, the present applicant conducted in-depth research, and found that a humidity indicator card includes an antistatic composition including conductive carbon black to prevent an electrostatic discharge phenomenon occurring between the humidity indicator card and the integrated circuit device, thereby developing the humidity indicator card which may secure device safety.

Hereinafter, the present invention will be described with reference to the attached drawings.

In one general aspect, a humidity indicator card with an added antistatic function includes: blotting paper; antistatic layers disposed on upper and lower portions of the blotting paper; and humidity indication units disposed on one surface of the antistatic layer, wherein the antistatic layer includes an antistatic composition including conductive carbon black, the conductive carbon black is included at 1 to 30 parts by weight based on 100 parts by weight of the antistatic composition.

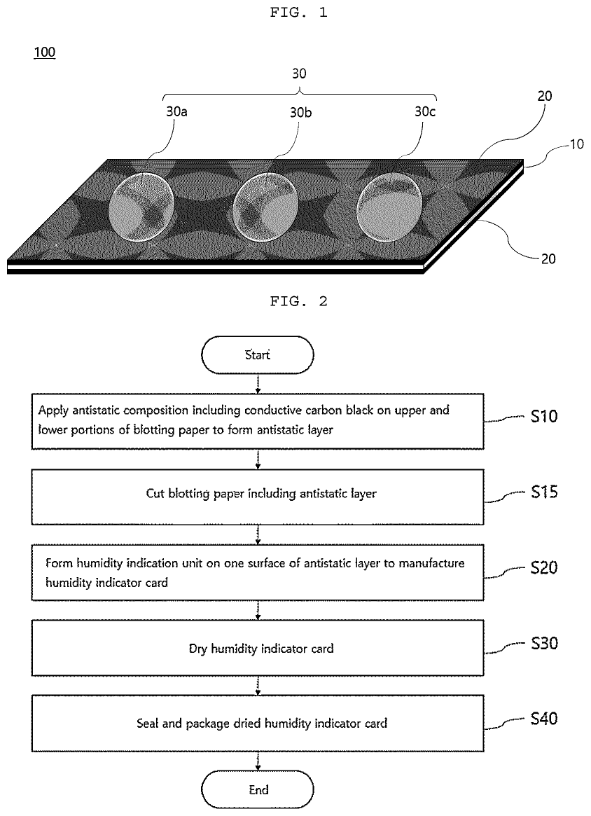

FIG. 1 is a drawing showing a humidity indicator card 100 according to an exemplary embodiment. As shown in FIG. 1, antistatic layers 20 are disposed on upper and lower portions of blotting paper 10, a plurality of humidity indication units 30 are disposed on one surface of the antistatic layer, and color changes of the humidity indication unit 30 occur depending on relative humidity, so that changes in humidity may be detected with the naked eye.

Since the humidity indicator card 100 has the antistatic layer 20 including the antistatic composition to decrease surface resistance of the humidity indicator card 100, an excellent antistatic function may be provided.

In an exemplary embodiment, 1 to 30 parts by weight, preferably 3 to 25 parts by weight, more preferably 5 to 20 parts by weight, and most preferably 10 to 20 parts by weight of the conductive carbon black may be included, based on 100 parts by weight of the antistatic composition. The conductive carbon black having high conductivity is included at the above parts by weight, and the mechanical properties of the antistatic layer 20 may be improved. In addition, the humidity indicator card 100 which is advantageous in terms of economic feasibility simultaneously with an excellent antistatic function may be provided.

The conductive carbon black has excellent conductivity and may have very different physical properties from those of conventionally used regular carbon black. As an example, the conductive carbon black may have a specific surface area of 50 to 100 m²/g or 60 to 90 m²/g, preferably 70 to 80 m²/g. Since the antistatic composition includes the conductive carbon black having the specific surface area in the above range, the antistatic function of the conductive carbon black is not deteriorated by moisture due to its excellent mechanical properties, thereby improving durability, and the conductive carbon black is easily mixed with the solvent and the binder of the antistatic composition described later, so that the conductive carbon black may be uniformly dispersed throughout the antistatic layer 20.

In addition, the conductive carbon black may have an oil absorption number (OAN) of 100 to 300 ml/100 g, preferably 150 to 250 ml/100 g, and more preferably 180 to 220 ml/100 g. Since the conductive carbon black having excellent crystallinity and a developed structure has the oil absorption number in the above range, high conductivity is shown, so that the antistatic composition including the conductive carbon black may significantly lower the surface resistance of the humidity indicator card 100, which is thus advantageous.

The conductive carbon black may contain less than 300 ppm, preferably less than 200 ppm, and most preferably less than 100 ppm of sulfur, and may contain 0.01 ppm or more of sulfur without limitation. The conductive carbon black may contain a low concentration of impurities such as sulfur and metal to improve the conductivity of conductive carbon black, and since a risk of humidity indication performance degradation by the impurities is significantly decreased, the humidity indicator card may maintain high sensitivity.

In an exemplary embodiment, the humidity indicator card 100 may have a surface resistance of 10³ to 10⁷ Ω/sq, preferably 10⁴ to 10⁷ Ω/sq, and more preferably 10⁵ to 10⁷ Ω/sq. As described above, the humidity indicator card 100 of the present invention has the antistatic layer 20 including conductive carbon black on upper and lower portions of the blotting paper 10, thereby having very low surface resistance to prevent static electricity, and thus, when products sensitive to static electricity such as electronic devices such as semiconductors and printed circuit boards, automobile parts, communication devices, optical devices, and sensors are enclosed with the humidity indicator card 100 of the present invention, problems such as failure and explosion of the product by static electricity may be prevented.

In an exemplary embodiment, the antistatic composition may further include a binder and a solvent. The binder may include a rosin-based resin, specifically, the rosin-based resin may include a rosin-modified phenol resin, rosin ester, a rosin modified maleic acid resin, or a combination thereof, and more specifically, the binder may include a rosin-modified phenol resin.

Since the porous blotting paper 10 is formed of a porous structure for easily absorbing moisture and has irregularities on the surface. Specifically, the blotting paper may have a surface roughness of 20 μm or less, 10 μm or less, or 5 μm or less, and 0.1 μm or more without limitation. As the blotting papter 10 includes irregularities, adhesion between the blotting paper 10 and the antistatic layer 20 may be decreased. Therefore, the antistatic composition further includes the binder to improve adhesion between blotting paper 10 including irregularities and the antistatic layer 20, thereby improving durability of the humidity indicator card 100.

In an exemplary embodiment, the solvent may include a vegetable oil, and the vegetable oil may include, for example, one or two or more selected from the group consisting of linseed oil, soybean oil, sunflower seed oil, and castor oil, preferably, may include linseed oil and soybean oil, but the present invention is not limited thereto, and other previously known vegetable oils may be used. Since the antistatic composition further includes the solvent including the vegetable oil and the binder including the rosin-based resin, the conductive carbon black may be uniformly dispersed in the antistatic composition to improve workability.

As a more specific example, the antistatic composition may include 0.1 to 10 parts by weight or 0.3 to 8 parts by weight, preferably 0.5 to 7 parts by weight of the binder, based on 1 part by weight of the conductive carbon black. In addition, the antistatic composition may include 1 to 20 parts by weight or 1 to 17 parts by weight, preferably 1 to 13 parts by weight of the solvent, based on 1 part by weight of the conductive carbon black. Since the antistatic composition includes the solvent and the binder at the above part by weight, workability is improved, so that the antistatic layer 20 having a uniform thickness may be formed on the surface of the blotting paper 10.

In an exemplary embodiment, the antistatic composition may further include a polypyrrole-based polymer having conductivity. Without being necessarily limited to the interpretation, when a polypyrrole-based polymer which is very stable in an oxidation state and has excellent stability and high conductivity is further included, excellent conductivity is maintained even in the case of being exposed to a humid environment, so that the antistatic effect of the humidity indicator card may be reinforced, which is thus advantageous.

In an exemplary embodiment, blotting paper 10 is a kind of specially made paper so that moisture is well absorbed, and may have a basis weight of 300 to 400 g/m², 305 to 380 g/m², 310 to 360 g/m², and 315 to 340 g/m², substantially 315 to 320 g/m². In addition, the blotting paper may have a thickness of 400 to 500 μm, 410 to 490 μm, 420 to 480 μm, and 430 to 470 μm, substantially 440 to 460 μm. The blotting paper 10 having a large thickness to a basis weight which refers to a weight of paper per unit area includes a plurality of pores to have excellent hygroscopicity.

More specifically, the blotting paper 10 may have a moisture absorption degree of 40 to 200 seconds, 60 to 180 seconds, 80 to 160 seconds, and substantially 100 to 150 seconds. The moisture absorption degree is a measurement of time required for blotting paper 10 to be completely wet with water, and since the blotting paper 10 has the moisture absorption degree in the above range, it may accurately detect relative humidity for a long time with high durability.

In an exemplary embodiment, the humidity indication unit 30 may not include the antistatic composition. When the antistatic composition including the conductive carbon black is applied on the humidity indication unit 30, the humidity indication unit 30 is colored, so that it may be difficult to distinguish color changes depending on humidity changes with the naked eye. Therefore, the antistatic composition is applied on an area excluding the humidity indication unit 30, so that the humidity indicator card 100 may provide an antistatic effect and also clearly observe color changes due to humidity changes.

In addition, since the blotting paper 10 having the basis weight and the moisture absorption degree properties is used, the antistatic composition is prevented from polluting the humidity indication unit 30 by moisture, thereby improving the durability and the lifespan of the humidity indicator card 100.

In an exemplary embodiment, the humidity indicator card 100 may include a plurality of humidity indication units 30. By setting different critical humidity values for each humidity indication unit 30a, the color of each humidity indication unit 30a may be sequentially changed with increasing relative humidity. As a non-limiting and specific example, when the relative humidity is 10% or more, the color of a first humidity indication unit 30a may be changed, when the relative humidity is 30% or more, the color of a second humidity indication unit 30b is changed, and when the relative humidity is increased to 50% or more, the color of the third humidity indication unit 30c is changed, so that humidity changes may be more sensitively identified.

In an exemplary embodiment, the humidity indication unit 30 includes a humidity indicator containing an indicator solution which changes color depending on pH, and the color of the humidity indication unit 30 may change depending on relative humidity. Specifically, the colors of the humidity indication unit 30 at a critical humidity value or lower and at a critical humidity value or higher are different, and humidity changes may be conveniently observed with the naked eye.

As a non-limiting example, the number of humidity indication units 30 may be 1 to 20, specifically 2 to 15, and more specifically 3 to 10, but the present invention is not limited thereto.

The present invention includes a method for manufacturing a humidity indicator card 100 with an added antistatic function.

In describing the method for manufacturing a humidity indicator card 100 of the present invention, since the blotting paper 10, the antistatic composition, the antistatic layer 20, the humidity indication unit 30, the material, structure, and shape or the size of the humidity indicator, and the like are the same as or similar to those of the humidity indicator card 100, the method for manufacturing a humidity indicator card according to the present invention includes all descriptions in the humidity indicator card 100.

The method for manufacturing a humidity indicator card 100 with an added antistatic function according to the present invention includes: (S10) applying an antistatic composition including conductive carbon black on upper and lower portions of blotting paper 10 to form antistatic layers 20; (S20) forming humidity indication units 30 on one surface of the antistatic layer 20 to manufacture a humidity indicator card 100; and (S30) drying the humidity indicator card 100, as shown in the flow chart of FIG. 2, wherein the conductive carbon black is included at 1 to 30 parts by weight based on 100 parts by weight of the antistatic composition.

In an exemplary embodiment, in (S10), the antistatic composition may be applied on the upper and lower portions of the blotting paper 10 by any one method of silk screen printing, gravure printing, offset printing, lithography, or flexography to form the antistatic layer 20. When forming the antistatic layer 20, an area on which the antistatic composition is applied is set in advance by a program, thereby applying the antistatic composition excluding an area of the humidity indication unit 30.

FIG. 3 is a drawing showing the blotting paper 10 on which the antistatic layer 20 is formed by applying the antistatic composition on the upper and the lower portion of the blotting paper 10. As shown in FIG. 3, the antistatic composition is printed on the upper and lower portions of the blotting paper 10, thereby manufacturing the blotting paper 10 on which a plurality of humidity indicator cards 100 are formed. The blotting paper 10 on which the antistatic composition is printed is cut to manufacture a single humidity indicator card 100.

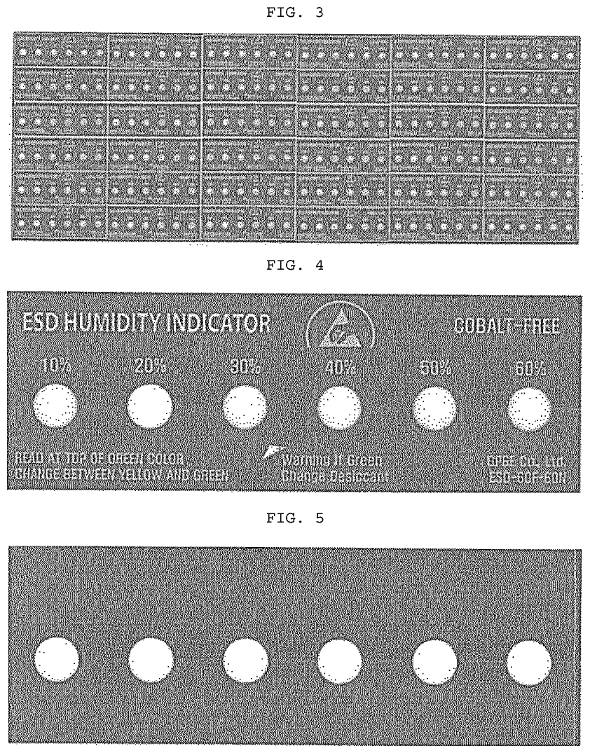

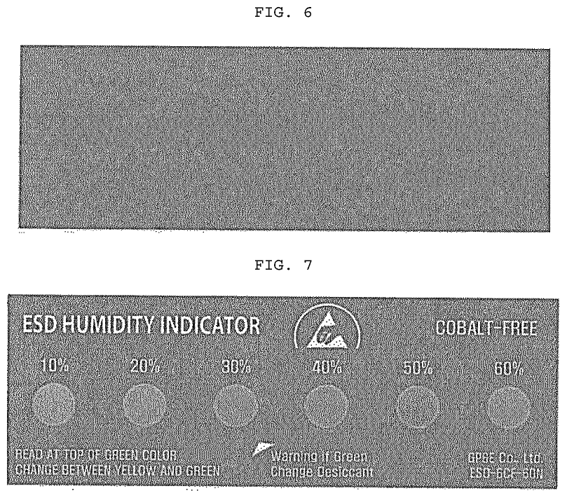

FIGS. 4 to 6 are drawings showing the blotting paper 10 cut in (S15). Specifically, FIG. 4 is a drawing showing the upper portion of the blotting paper 10, and FIGS. 5 and 6 are drawings showing the lower portion of the blotting paper 10. When the antistatic composition is applied, it is applied excluding the area of the humidity indication unit (30) and the humidity indication unit 30 does not include conductive carbon black, so that the color changes of the humidity indication unit 30 depending on the changes in relative humidity may be clearly distinguished. The antistatic composition may be printed on the lower portion of the blotting paper 10 excluding the area of the humidity indication unit 30 as shown in FIG. 5, or the antistatic composition may be printed on the area of the humidity indication unit 30 on the lower portion of the blotting paper 10 to form the antistatic layer 30 as shown in FIG. 6.

In (S20), the humidity indicator may be impregnated in an area where the antistatic composition is not applied, on the upper portion of the blotting paper 10, thereby forming the humidity indication unit 30.

In a preferred example, the humidity indicator may include an indicator solution containing a main indicator solution which changes color depending on pH, an auxiliary indicator solution which adjusts pH so that the color changes depending on relative humidity, and an additive which changes pH of the humidity indicator solution depending on relative humidity. The indicator solution is advantageous, since it does not include cobalt and heavy metals which are potential carcinogenic substances and may produce an environmentally friendly humidity indicator card 100.

The main indicator solution may be a known acid-base indicator solution, and may be, representatively, for example, thymol blue, resazurin, and the like. The auxiliary indicator solution may include one selected from the group consisting of sulfuric acid, hydrochloric acid, citric acid, oxalic acid, acetic acid, sodium hydroxide, and potassium hydroxide, and the additive may include a deliquescent material. More specifically, the humidity indication unit 30 may be manufactured with reference to Korean Patent Registration No. 10-1605193 or 10-1344949.

In a plurality of humidity indication units 30 included in the humidity indicator card 100, a content of an additive included in the humidity indicator may be adjusted to set a critical humidity value which is different from the separate humidity indication unit 30a. As described above, as the relative humidity increases, the color of the separate humidity indication unit 30 sequentially changes, respectively, and the relative humidity may be measured with high accuracy.

In another example, the humidity indicator may include one selected from the group consisting of cobalt chloride (CoCl₂), cobalt bromide (CoBr₂), and copper (Cu), but the present invention is not limited by the specific materials of the humidity indicator.

In (S30), the humidity indicator card 100 in which the humidity indicator is impregnated to the humidity indication unit 30 may be dried to manufacture the humidity indicator card 100 including the antistatic composition. A drying temperature may be 40 to 100° C., 45 to 90° C., 50 to 80° C., or 55 to 75° C., and may be substantially 55 to 70° C.

Since the antistatic composition includes conductive carbon black at the parts by weight described above, an antistatic function may last without decreasing even when a heat treatment is performed at a high temperature.

In (S40), the humidity indicator card 100 which has completed drying may be sealed and packaged. When sealed, the humidity indicator card may be sealed and packaged with a desiccant in a moisture-proof bag or a tin can in accordance with the standard specification of Electron Device Engineering Council (JEDEC) (IPC/JEDEC J-STD-033).

The completed humidity indicator card 100 may be enclosed with moisture-sensitive products and distributed. An example of the moisture-sensitive product may include, for example, semiconductors, printed circuit boards, surface-mounted devices (SMD), displays, communication devices, optical devices, precision analysis sensors, automobile components, electronic components, missile ammunition, gunpowder, propelling charge, and the like.

The moisture-sensitive product and the humidity indicator card 100 of the present invention are sealed together, thereby significantly reducing a risk of occurrences of malfunction, destruction, fire, and explosion of devices due to electrostatic discharge to improve safety.

Hereinafter, the present invention will be described in more detail by the examples.

### Example 1

An antistatic composition was applied on upper and lower portions of blotting paper having a basis weight of 320 g/m², a thickness of 450 μm, and a moisture absorption degree of 105 seconds by silk screen printing to form antistatic layers. The antistatic composition included conductive carbon black (DC3501-P2, OCI), a rosin-modified phenol resin as a binder, and a linseed oil and a soybean oil as a solvent, and 5 wt % of the conductive carbon black, 30 wt % of the binder, and 65 wt % of the solvent were added to prepare the antistatic composition. When the antistatic layer was formed, the antistatic composition was printed excluding an area of the humidity indication unit on upper and lower portions of the blotting paper.

The blotting paper on which the antistatic layer was printed was cut, and a humidity indicator was impregnated in one surface of the antistatic layer to form a humidity indication unit. Specifically, the humidity indication unit was manufactured by impregnating a humidity indicator in which a main indicator including methyl blue, a pH adjusting agent including acetic acid, a moisture absorption adjusting agent, a stabilizer including polysorbate, a UV blocking agent including Tinogard N from BASF, and a defoamer including Defom W-0506 from Elementis are mixed in an ethanol solvent. Thereafter, a humidity indicator card on which the humidity indication unit was formed was dried in an oven at 60° C. for 1 hour to manufacture a humidity indicator card.

### Example 2

A humidity indicator card was manufactured in the same manner as in Example 1, except that an antistatic composition including 10 wt % of conductive carbon black, 30 wt % of a binder, and 55 wt % of a solvent was used.

### Example 3

A humidity indicator card was manufactured in the same manner as in Example 1, except that an antistatic composition including 15 wt % of conductive carbon black, 30 wt % of a binder, and 55 wt % of a solvent was used.

### Example 4

A humidity indicator card was manufactured in the same manner as in Example 1, except that an antistatic composition including 20 wt % of conductive carbon black, 30 wt % of a binder, and 50 wt % of a solvent was used.

### Example 5

A humidity indicator card was manufactured in the same manner as in Example 1, except that an antistatic composition including 25 wt % of conductive carbon black, 30 wt % of a binder, and 45 wt % of a solvent was used.

### Example 6

A humidity indicator card was manufactured in the same manner as in Example 1, except that an antistatic composition including 30 wt % of conductive carbon black, 30 wt % of a binder, and 40 wt % of a solvent was used.

### Comparative Example 1

A humidity indicator card was manufactured in the same manner as in Example 1, except that the antistatic composition included regular carbon black (EG880, OCI).

### Comparative Example 2

A humidity indicator card was manufactured in the same manner as in Example 3, except that the antistatic composition included regular carbon black (EG880, OCI).

### Comparative Example 3

A humidity indicator card was manufactured in the same manner as in Example 1, except that the antistatic composition included 40 wt % of conductive carbon black, 20 wt % of a binder, and 40 wt % of a solvent.

### Comparative Example 4

A humidity indicator card was manufactured in the same manner as in Example 1, except that common paper having a moisture absorption degree of 250 seconds was used instead of blotting paper.

Contents of components included in the antistatic compositions of Examples 1 to 6 and Comparative Examples 1 to 4 are summarized in the following Table 1:

TABLE 1

| | Moisture | | | Binder | | |
|---|---|---|---|---|---|---|
| | absorption | Carbon black | | Rosin- | | |
| | degree of | Conductive | Regular | modified | Solvent | |
| | blotting paper | carbon | carbon | phenol | Linseed | Soybean |
| | (sec) | black | black | resin | oil | oil |
| Example 1 | 105 | 5 | — | 30 | 20 | 45 |
| Example 2 | 105 | 10 | — | 30 | 25 | 35 |
| Example 3 | 105 | 15 | — | 30 | 20 | 35 |
| Example 4 | 105 | 20 | — | 30 | 20 | 30 |
| Example 5 | 105 | 25 | — | 30 | 20 | 25 |
| Example 6 | 105 | 30 | — | 30 | 20 | 20 |
| Comparative | 105 | — | 5 | 30 | 20 | 45 |
| Example 1 | | | | | | |
| Comparative | 105 | — | 15 | 30 | 20 | 35 |
| Example 2 | | | | | | |
| Comparative | 105 | 40 | — | 30 | 20 | 20 |
| Example 3 | | | | | | |
| Comparative | 250 | 5 | — | 30 | 20 | 45 |
| Example 4 | | | | | | |

### (Experimental Example 1) Evaluation of Physical Properties of Carbon Black

The physical properties of the conductive carbon black of Example 1 and the regular carbon black of Comparative Example 1 were compared and are shown in the following Table 2. Specifically, a BET specific surface area was measured in accordance with the standard of ASTM D4820, an oil absorption number (OAN) was measured in accordance with the standard of ASTM D2414-00, and d-spacing was measured using an X-ray diffraction method.

TABLE 2

| | Specific | Oil | | | |
|---|---|---|---|---|---|
| | surface | absorption | | | |
| | area | number | d-spacing | Sulfur | Metal |
| | (m²/g) | (ml/100 g) | (nm) | (ppm) | (ppm) |
| Conductive | 70-80 | 195 | 0.345-0.350 | <100 | <50 |
| carbon | | | | | |
| black | | | | | |
| Regular | 180-200 | 55 | 0.365-0.370 | <5000 | <3000 |
| carbon | | | | | |
| black | | | | | |

As shown in FIG. 2, it is confirmed that the conductive carbon black used in Example 1 had very different physical properties from those of the regular carbon black.

Specifically, the specific surface area of the conductive carbon black was smaller than that of the regular carbon black, but the oil absorption number of the conductive carbon black was measured to be significantly higher than that of the regular carbon black. The conductive carbon black having the specific surface area was able to be uniformly dispersed in the antistatic composition, and also, considering its high oil absorption number, it was shown that its conductivity was excellent due to the developed structure of the conductive carbon black. However, it is shown that the regular carbon black had a higher dispersion difficulty due to its higher specific surface area, and had lower conductivity due to its significantly lower oil absorption number than the conductive carbon black.

In the case of the d-spacing which refers to a distance between (002) planes of carbon black, since the d-spacing value of the conductive carbon black was shorter than that of the regular carbon black, it is shown that the crystallinity of the conductive carbon black was improved. In addition, when the concentrations of sulfur and metal which are included in carbon black and act as impurities were compared, the concentration of impurities included in the conductive carbon black was measured to be significantly lower than that in the regular carbon black.

Therefore, since the conductive carbon black having significantly different physical properties from those of the regular carbon black had excellent crystallinity and a developed structure, it had significantly improved conductivity, and may contribute to lowering the surface resistance of the humidity indicator card. Simultaneously, since the conductive carbon black having the specific surface area in an appropriate range had improved dispersibility and was uniformly dispersed in the antistatic composition, it may implement a uniform antistatic effect throughout the antistatic layer. In addition, since the conductive carbon black having a significantly decreased content of impurities such as sulfur and metal was used, conductivity was improved, a risk of deteriorating humidity indication performance of the humidity indication unit by impurities was significantly reduced, and thus, the humidity indicator card including the antistatic composition may measure relative humidity with high sensitivity.

### (Experimental Example 2) Evaluation of Antistatic Function

The surface resistance of the humidity indicator card manufactured by the methods of Examples 1 to 6 and Comparative Examples 1 to 4 was measured using SIMCO ST-4. The results of measuring surface resistance are shown in the following Table 3:

TABLE 3

| | Surface resistance (Ω/sq) |
|---|---|
| Example 1 | 10^{6.8} |
| Example 2 | 10^{6.1} |
| Example 3 | 10^{5.6} |
| Example 4 | 10^{5.9} |
| Example 5 | 10^{7.3} |
| Example 6 | 10^{7.5} |
| Comparative Example 1 | 10^{14.5} |
| Comparative Example 2 | 10^{14.1} |
| Comparative Example 3 | 10^{14.8} |
| Comparative Example 4 | 10^{15.3} |

Since the humidity indicator cards of Examples 1 to 6 had significantly lower surface resistance than that of Comparative Examples 1 to 3, their antistatic effect was confirmed to be excellent. In particular, since the humidity indicator cards of Examples 1 to 4 including 5 to 20 parts by weight of the conductive carbon black based on 100 parts by weight of the antistatic composition showed a surface resistance value of 10⁷ Ω/sq or less, it is shown that they had an excellent antistatic effect.

However, since the humidity indicator cards of Comparative Examples 1 to 3 had a surface resistance of 10¹⁴ Ω/sq or more, it was confirmed that they showed significantly higher surface resistance than that of Examples 1 to 6, and did not provide an antistatic effect.

Specifically, the humidity indicator cards of Comparative Examples 1 and 2 used an antistatic composition including regular carbon black instead of conductive carbon black. Since the regular carbon black had lower conductivity than the conductive carbon black, included impurities, and had decreased conductivity when mixed with a binder and a solvent, its surface resistance was measured to be high.

In the case of Comparative Example 3, since the conductive carbon black was excessively included in the antistatic composition and the contents of the solvent and the binder were decreased, the viscosity of the antistatic composition was increased. Therefore, it is shown that since the antistatic composition was not uniformly dispersed on the surface of the blotting paper, the antistatic effect was not implemented.

Comparative Example 4 was a humidity indicator card manufactured using plain paper having a moisture absorption degree of 250 seconds instead of blotting paper having a moisture absorption degree of 105 seconds, and showed very higher surface resistance than the humidity indicator card of Example 1 using the blotting paper and confirmed to have no antistatic effect. In addition, since the color of the humidity indication unit was not clearly changed even with an increase in humidity, it was difficult to distinguish the humidity change with the naked eye. Thus, when the humidity indicator card was manufactured using plain paper instead of the blotting paper, the antistatic effect was not able to be provided due to the high surface resistance, moisture in the air was not able to be rapidly absorbed, and thus, the humidity change was not able to be displayed in detail.

The humidity indicator card according to the present invention is provided with an antistatic function, so that a product packaged with the humidity indicator card may not be damaged by static electricity.

Hereinabove, although the present disclosure has been described by specific matters, limited exemplary embodiments, and drawings, they have been provided only for assisting the entire understanding of the present disclosure, and the present disclosure is not limited to the exemplary embodiments, and various modifications and changes may be made by those skilled in the art to which the present disclosure pertains from the description.

Therefore, the spirit of the present invention should not be limited to the above-described exemplary embodiments, and the following claims as well as all modifications equal or equivalent to the claims are intended to fall within the scope and spirit of the invention.

What is claimed is:

1. A humidity indicator card with an added antistatic function comprising:
blotting paper;
antistatic layers disposed on upper and lower portions of the blotting paper; and
humidity indication units disposed on one surface of the antistatic layer,
wherein the antistatic layer includes an antistatic composition including conductive carbon black, and
the conductive carbon black is included at 1 to 30 parts by weight based on 100 parts by weight of the antistatic composition.

2. The humidity indicator card of claim 1, wherein the antistatic composition further includes a binder and a solvent.

3. The humidity indicator card of claim 2, wherein the binder includes a rosin-based resin.

4. The humidity indicator card of claim 2, wherein the solvent includes a vegetable oil.

5. The humidity indicator card of claim 1, wherein the conductive carbon black has a specific surface area of 50 to 100 m²/g.

6. The humidity indicator card of claim 1, wherein the conductive carbon black has an oil absorption number (OAN) of 100 to 300 ml/100 g.

7. The humidity indicator card of claim 1, wherein the conductive carbon black contains less than 300 ppm of sulfur.

8. The humidity indicator card of claim 1, wherein the blotting paper has a moisture absorption degree of 40 to 200 seconds.

9. The humidity indicator card of claim 1, wherein the blotting paper has a thickness of 400 to 500 μm.

10. The humidity indicator card of claim 1, wherein the humidity indicator card has a surface resistance of 10³ to 10⁷ Ω/sq.

11. The humidity indicator card of claim 1, wherein the antistatic composition further includes a polypyrrole-based polymer.

12. The humidity indicator card of claim 1, wherein the humidity indication unit does not include the antistatic composition.

13. A method for manufacturing a humidity indicator card with an added antistatic function, the method comprising:
(S10) applying an antistatic composition including conductive carbon black on upper and lower portions of blotting paper to form antistatic layers;
(S20) forming humidity indication units on one surface of the antistatic layer to manufacture a humidity indicator card; and
(S30) drying the humidity indicator card,
wherein the conductive carbon black is included at 1 to 30 parts by weight based on 100 parts by weight of the antistatic composition.

14. The method for manufacturing a humidity indicator card of claim 13, wherein in (S30), a drying temperature is 40 to 100° C.

15. The method for manufacturing a humidity indicator card of claim 13, wherein in (S10), the antistatic composition is applied excluding an area of the humidity indication unit.

16. The method for manufacturing a humidity indicator card of claim 13, further comprising: after (S10), (S15) cutting the blotting paper including the antistatic layer.

17. The method for manufacturing a humidity indicator card of claim 13, further comprising: after (S30), (S40) sealing the dried humidity indicator card.
